(19) United States
(12) Patent Application Publication
(10) Pub. No.: US 2008/0280717 A1
(43) Pub. Date: Nov. 13, 2008

(54) CHAIN LINK FOR A POWER TRANSMISSION CHAIN, AND POWER TRANSMISSION CHAIN HAVING AN EXPANDED USEFUL CROSS SECTION

(76) Inventor: Herbert Wehler, Neunkirchen (DE)

Correspondence Address: Jeffry W. Smith;Smith Law Office, 440 Science Drive, Suite 302, Madison, WI, 53711, US

(21) Appl. No.: 11/579,310

(22) PCT Filed: Apr. 29, 2005
(86) PCT No.: PCT/EP05/04677

§ 371 Date: Jul. 7, 2008

(30) Foreign Application Priority Data
May 5, 2004 (DE) 10 2004 022 512.5

(51) Int. Cl. F16G 13/02

(52) U.S. Cl. 474/227; 474/228

(57) ABSTRACT

The invention relates to a chain link of a power transmission unit for guiding cables, tubes, or similar. Said chain link comprises two side plates (1, 2) which are interconnected by means of at least one transversal web (3, 4). Each side plate (1, 2) is provided with one respective zone that is used for hingedly connecting the same to another side plate (1, 2). The distances (a, b) between the swivel pins (7, 8) and the longitudinal edges of the sideplates (1, 2) are different.

The subject matter of the invention concerns a chain link for a power transmission chain, and a power transmission chain for guiding lines, tubes or the like.

Power transmission chains are predominantly used when a movable component, in particular a component which moves essentially on predetermined paths, has to be supplied, for example with power, water, compressed air, current-using means or the like. In this case, lines have to be guided from a fixed point to the component in such a manner that a movement of the component on its predetermined path of movement is made possible without the lines becoming damaged in the process.

A power transmission chain comprises chain links which are connected to one another in an articulated manner, the power transmission chain being moved along a predetermined path. In this case, the lines are guided in the power transmission chain in a predetermined manner, so that the lines are subjected only to a very small degree of wear—if any at all.

A chain link has two side plates which the lateral boundary of the chain link at least one transverse web which forms the upper and/or lower boundary of the chain link. The chain links are designed in such a manner that in each case one chain link can be connected to at least one adjacent chain link and/or at least one end piece in order thus to construct the power transmission chain. This connection generally takes place via corresponding connecting means which is formed correspondingly in adjacent chain side plates.

Chain side plate and transverse web can be formed as a single part, for example can be formed, in particular injection moulded from a plastic, but it is also customary to form transverse webs and chain side plates in such a manner that they can be connected releasably to one another. A releasable connection of the chain side plate to at least one transverse web has the advantage of access to the channel formed by the chain links being easy, so that laying lines into or removing them from the power transmission chain, and possible access to the lines for maintenance purposes are easily possible.

DE 197 15 532 C1 discloses, for example, a power transmission chain for receiving cables, tubes or the like. It has a number of chain links which are connected to one another in an articulated manner and are formed by side plates parallel to one another and transverse webs connecting the latter. Each side plate has lateral latching projections, which are directed inward with respect to the chain, for the releasably latching engaging of correspondingly designed transverse webs. In order to expand the useful cross section of the power transmission chain in a modular manner, it is proposed according to DE 197 15 532 C1 that at least some of the transverse webs are designed as clips which, at least on one side, form an expansion of the chain cross section which is bounded by the parallel upper and lower edges of the side plates. At their ends, the clips have fastening regions which are designed corresponding to the fastening regions of the transverse webs, so that the clips can be placed instead of the transverse webs onto the latching projections.

Taking this as the starting point, the present invention is based on the object of indicating a chain link and a power transmission chain which are designed in a stable manner with an expanded useful cross section.

This objective is achieved according to the invention by a chain link with the features of claim 1. Advantageous developments and refinements of the chain link are the subject matter of the independent claims.

The chain link according to the invention of a power supply chain for guiding lines, tubes or the like has two side plates which are connected to each other by at least one transverse web. Each side plate has in each case an end region which is intended for articulated connections to another side plate. In the case of the chain link according to the invention, the distances of the axes of articulation from the longitudinal edges of the side plates are selected in such a manner that they differ.

Unlike in the previous configuration of chain side plates, in which the axes of articulation lie essentially halfway up the side plate, in the case of the chain link according to the invention it is proposed that the distances of the axes of articulation from the longitudinal edges of the side plates differ. This measure creates the possibility of providing a chain link which, while having the same pitch, has a larger useful cross section than has hitherto been the case in chain links of the same pitch. Furthermore, the chain link is formed in a relatively stable manner, since the side plates make a substantial contribution to the stability of the chain link.

The configuration according to the invention of the chain link affords the advantage that said chain links can be used to configure a power transmission chain, and this power transmission chain can be used wherever the installation ratios are predetermined, with the useful cross section being increased but the radius of curvature or the pitch corresponding to the original power transmission chain.

According to an advantageous configuration of the chain link, it is proposed that the chain link is designed in such a manner that the ratio of the smaller distance from the larger distance is smaller than 0.9, preferably smaller than 0.7. This also ensures that a risk of the chain link tilting is avoided. At smaller ratios, it may be expedient under some circumstances to guide a power transmission chain constructed from the chain links according to the invention in a guide duct.

According to an advantageous configuration of the chain link, it is proposed that the side plates are of essentially trapezoidal design. Trapezoidal is not strictly to be understood in the mathematical sense. The side plate can be formed, for example, from an essentially rectangular part with a trapezoid arranged thereon. The essentially trapezoidal configuration of the side plates also ensures that the pivoting range and therefore the radius of curvature of the chain links can be appropriately selected.

To limit a deflection of adjacent chain links when the latter are connected to one another in an articulated manner, it is proposed according to yet another advantageous configuration of the chain link that at least one stop is provided.

The connection of two chain links is formed in an articulated manner. For this purpose, the one end region of a side plate has an articulated body and the other end region has an articulated mount. The articulated mount is designed corresponding to the articulated body. This is not absolutely necessary. There is also the possibility for the end regions merely to have articulated mounts and for an articulated body which forms a separate part to be used for articulated connections.

According to yet another advantageous configuration of the chain link, it is proposed that the articulated body is of essentially cylindrical design and the articulated mount has an essentially oval cross section. Alternatively, the articulated body can have an essentially oval cross section and the articulated mount can have a circular cross section.

Such a configuration of the chain links creates the possibility of providing a power transmission chain which can be deflected essentially transversely with respect to the longitudinal direction of the power transmission chain.

The articulated body or the articulated mount is preferably of essentially oval design in cross section. An oval cross section is also understood as meaning a race-track shape. The distance between the sections of the race-track shape which run essentially parallel to one another essentially corresponds to the profile of the articulated body, so that the articulated body can be pivoted about its longitudinal axis. Owing to the fact that the articulated mount has an essentially oval cross section, there is play between the articulated body and the articulated mount making it possible for there to be deflection about an axis running essentially perpendicular to the longitudinal axis of the articulated body and to the longitudinal direction of the power transmission chain.

The chain side plates and/or at least one transverse web are preferably produced as a single part from a plastic. The chain link is then of essentially U-shape design. The chain side plates can be designed with a transverse web forming a closing clip or a closing cover, thus permitting access to the channel of the power transmission chain. It is thereby also possible to retrospectively lay lines in the channel or to remove individual lines from the channel. It is also possible to check the individual lines in the power transmission chain without them having to be removed from the power transmission chain.

The chain link is preferably at least partially composed of at least one plastic. It is possible to use different pairings of plastic to form configurations of the chain link. In this case, for example, chain side plates can be produced from a relatively firm plastic while the transverse webs are composed, for example, of a second plastic which have a lower strength. However, this is not absolutely necessary.

The object is also achieved according to the invention by a power transmission chain for guiding lines, tubes or the like with the features of claim 9. Advantageous developments and configurations of the power transmission chain according to the invention are the subject matter of the dependent claims.

The power transmission chain according to the invention for guiding lines, tubes or the like between a positionally fixed and a movable connection has chain links which are connected to one another in an articulated manner. The chain links limit a channel section extending in the direction of the power transmission chain, each chain link having two side plates which are connected to each other by at least one transverse web. Each side plate has in each case an end region which is intended for the articulated connection to a side plate of another chain link. The power transmission chain according to the invention is distinguished in that at least one chain link is provided, the side plates of which are designed in such a manner that the distances of the axes of articulation from the longitudinal edges of the side plates differ.

The ratio of the smaller distance to the larger distance is preferably smaller than 0.9, preferably smaller than 0.7. In particular, it is proposed that the side plates of at least one chain link are of essentially trapezoidal design.

According to an advantageous configuration of the power transmission chain, it is proposed that a respective clearance is provided between the partially overlapping side plates of two adjacent chain links, and that the articulated body has two diametrically opposite outer casing regions and the articulated mount has two diametrically opposite inner casing regions and only the outer casing regions and the inner casing regions bear against one another. This configuration ensures that the chain links are capable of moving about an axis running essentially transversely with respect to the longitudinal direction of the power transmission chain. The pivotability of the individual chain links relative to one another is achieved by only the outer casing regions and the inner casing regions bearing against one another. A play is provided between the further casing regions of the articulated body and the articulated mount, permitting deflectability essentially transversely with respect to the longitudinal direction of the power transmission chain.

In particular, it is proposed that the normals of the outer casing regions and of the inner casing regions run essentially perpendicular to the longitudinal direction of the power transmission chain. The articulated body is of essentially cylindrical design and the articulated mount has an essential oval cross section. A reverse construction is also possible. To this end, the articulated body is of essentially oval design in cross section while the articulated mount has a circular cross section.

According to a further advantageous configuration of the power transmission chain according to the invention, it is proposed that two adjacent chain links can be pivoted relative to each other at an angle of approx. 45°.

According to yet another advantageous configuration of the power transmission chain according to the invention, it is proposed that the articulated body is formed from articulated body segments separated from one another by slots. In particular, the articulated body has a radially outwardly directed collar in the region of its free end section. In the case of such a configuration of the articulated body, the articulated body or its articulated body segments is/are compressed when passing the articulated body through the articulated mount, so that the articulated body or the articulated body segments, after being passed through, returns/return into its/their starting position, with the result that the collar engages around the edge of the articulated mount. This creates a releasable connection between the chain links by latching. The collar has a certain safety function, since it permits an improved support of the chain links. In order to ensure that the collar does not take on a carry-along function during operation of the power transmission chain, it is proposed that a depression in which the collar engages with play is provided concentrically with respect to an articulated mount. In particular, the depression is dimensioned in such a manner that the collar does not protrude laterally from the chain side plate. Should the side surface of the chain side plate drag along an object, the collar is not worn down since it is arranged within the chain side plate. This arrangement also avoids a possible risk of injury in comparison to a collar which protrudes from the chain side plate.

According to yet another advantageous configuration of the power transmission chain, it is proposed that at least one transverse web can be connected releasably at one end to a side plate and is connected to the other side plate by a film hinge. The chain side plate, the film hinge and the transverse web are preferably produced as a single piece from a plastic.

In particular, it is proposed that, in the region of the film hinge, the transverse web has at least one projection, so that, in a closed position of the transverse web, the projection rests on an edge of the chain side plate. This relieves the film hinge from load when the transverse web has taken up the closed position and a force in the direction of a channel section is exerted on the transverse web. The force here is absorbed by the projection, so that the film hinge is kept essentially free from load. According to yet another advantageous configuration, it is proposed that the transverse web forms a cover.

To limit the pivoting angle of adjacent chain side plates about an axis running essentially transversely with respect to the longitudinal direction of the power transmission chain, it is proposed that at least one side plate has a stop element at one end and a stop surface at the other end, the stop surface being formed essentially parallel to a central plane of the side plate. This configuration of the side plates has the effect that, during a lateral pivoting of adjacent chain side plates, because of the stop and the stop surface no distortion of the chain links or of the side plates occurs.

The chain links of the power transmission chain or the power transmission chain as such is preferably produced from a plastic. In particular, this may be glass-fiber-reinforced plastic. The chain links and/or their components can be cast or injection molded. There is also the possibility of the chain links being produced according to the two-component injection molding method.

The power transmission chain according to the invention is suitable in particular for use for a sliding door system of a vehicle, in particular of a motor vehicle. The motor vehicle may be a transport vehicle or a passenger vehicle which may also be referred to as a van, mini van or microvan. A vehicle of this type has at least one sliding door which is arranged movably essentially in the longitudinal direction of the vehicle. The vehicle body has suitable guide means for this. The means may be roller guides in which rollers which are arranged on an arm which is connected to the sliding door. The roller guides for a sliding door in particular for a motor vehicle are known, for example, by DE 177 23 837 A1.

The power supply of electric consumers in a sliding door has proven problematic. The electric consumers may be, for example, speakers, electrically actuable window lifters or electrically actuable locking systems.

A sliding door system for a vehicle, in particular for a motor vehicle, has at least one sliding door which is movable between a closed position and an open position. The system has at least one power transmission chain which is connected at one end to the sliding door and can be connected at another end to the vehicle body. The power transmission chain can be provided with a plurality of different lines, in particular electric line, so that, for example, an electric consumer which is arranged in the sliding door is connected to an electric system of the vehicle via an electric line guided in the power transmission chain. The power transmission chain has at least one region of curvature situated between the ends. The sliding door system is distinguished, in particular, in that at least one power transmission chain is provided in which there is at least one chain link, the side plates of which are designed in such a manner that the distances of the axes of articulation from the longitudinal edges of the side plates differ. Advantageous configurations of the power transmission chain are indicated in the dependent claims.

The power transmission chain creates the possibility of arranging a multiplicity of lines therein without the pitch and/or the radius of curvature of the power transmission chain having to be changed.

Further advantages and details of a chain link and of a power transmission chain are explained with reference to the exemplary embodiments illustrated in the drawing without the subject matter of the invention being restricted to the specific exemplary embodiments.

### IN THE DRAWING

FIG. 1 shows a front view of a chain link,

FIG. 2 shows a side view of the chain link according FIG. 1,

FIG. 3 shows a plan view of the chain link according to FIG. 1,

FIG. 4 shows a bottom view of the chain link according to FIG. 1,

FIG. 5 shows, on an enlarged scale, an articulated connection between adjacent chain links,

FIG. 6 shows the articulated connection according to FIG. 5 in section and in a plan view,

FIG. 7 shows a chain link in a front view and in section in the open state,

FIG. 8 shows the chain link according to FIG. 7 in the closed state,

FIG. 9 shows a section of a power transmission chain with open chain links, and

FIG. 10 shows a section of a power transmission chain with closed chain links.

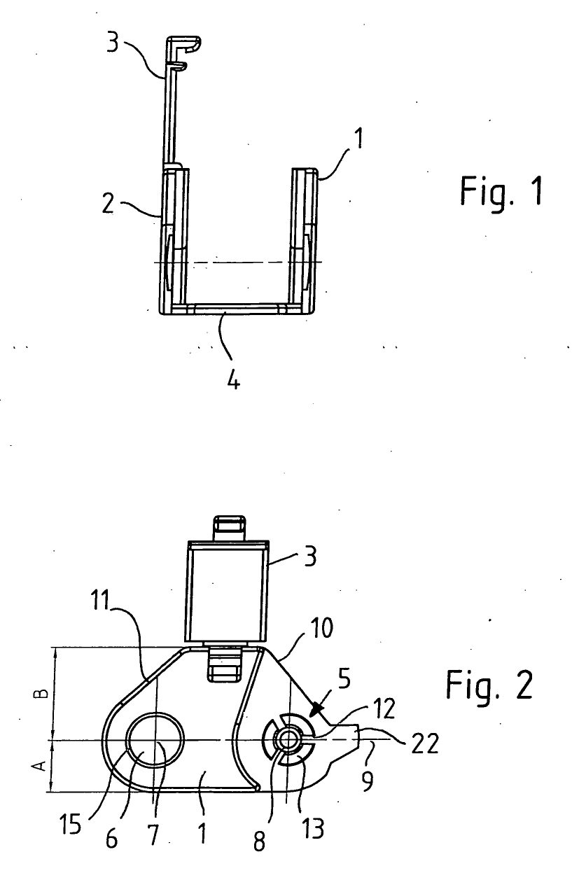

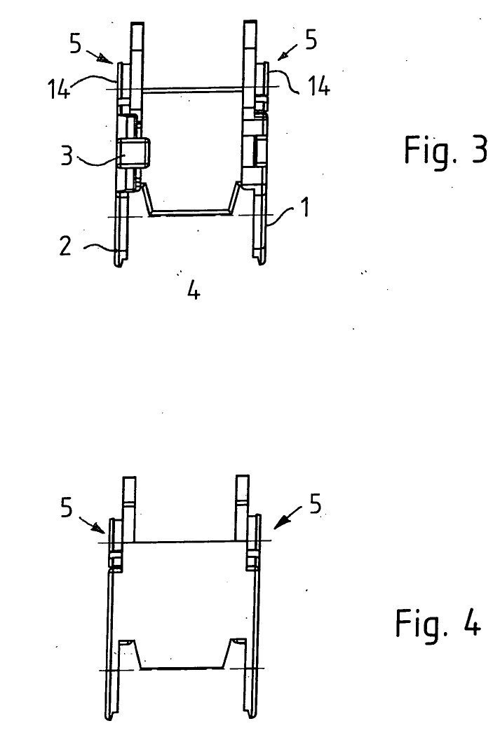

FIGS. 1 to 4 show an exemplary embodiment of a chain link for a power transmission chain for guiding lines. The chain link has two chain side plates 1, 2 which are spaced apart from each other, lie opposite each other and extend in a longitudinal direction of a power transmission chain.

The chain side plates 1, 2 can be connected to each other by transverse webs 3, 4. In the exemplary embodiment illustrated, the lower transverse web 4 is formed as a single piece with the side plates 1, 2, so that the side plates 1, 2 and the lower transverse web 4 form a U-shaped component. The side plates 1, 2 each have an end region which is intended for the articulated connection to another side plate.

FIG. 2 illustrates that the one end region has an articulated body 5, while the other end region has an articulated mount 6. The axes of articulation 7, 8 lie on an imaginary line 9 running essentially parallel to the longitudinal edges of the side plate. The reference symbol A refers to the distance of the axes of articulation from the lower longitudinal edge of the side plate while the reference symbol B refers to the distance of the axes of articulation from the upper longitudinal edge of the side plate. The distances A, B of the axes of articulation 7, 8 from the longitudinal edges of the side plate 1 differ. The ratio of the smaller distance A to the larger distance B is preferably smaller than 0.9, preferably smaller than 0.7.

It can be seen from FIG. 2 that the side plate 1 and, in a corresponding manner, the side plate 2 of the chain link partially have a trapezoidal form. The side edges 10, 11 are inclined with respect to each other. The angle of inclination is dependent on the pivoting angle of two adjacent chain links which are connected to each other in an articulated manner.

In the exemplary embodiment illustrated, the articulated mount 6 is of essentially oval design in cross section. The articulated body 5 has an essentially circular cross section. The articulated connection between two adjacent chain links takes place via the articulated bodies 5 which engage in the articulated mount 6. The articulated body 5 is formed from articulated body segments 13 which are separated from one another by slots 12. On its free end section, the articulated body 5 has a radially outwardly directed collar 14. The collar 14 is also divided by the slots 12. In the exemplary embodiment illustrated in FIG. 2, the slots 12 are designed such that they are offset with respect to one another by 120°.

The articulated mount 6 has an encircling depression 15. The depression 15 is formed essentially coaxially with respect to the articulated mount 6. The depth and the width of the articulated mount essentially corresponds to the cross-sectional shape of the collar 14.

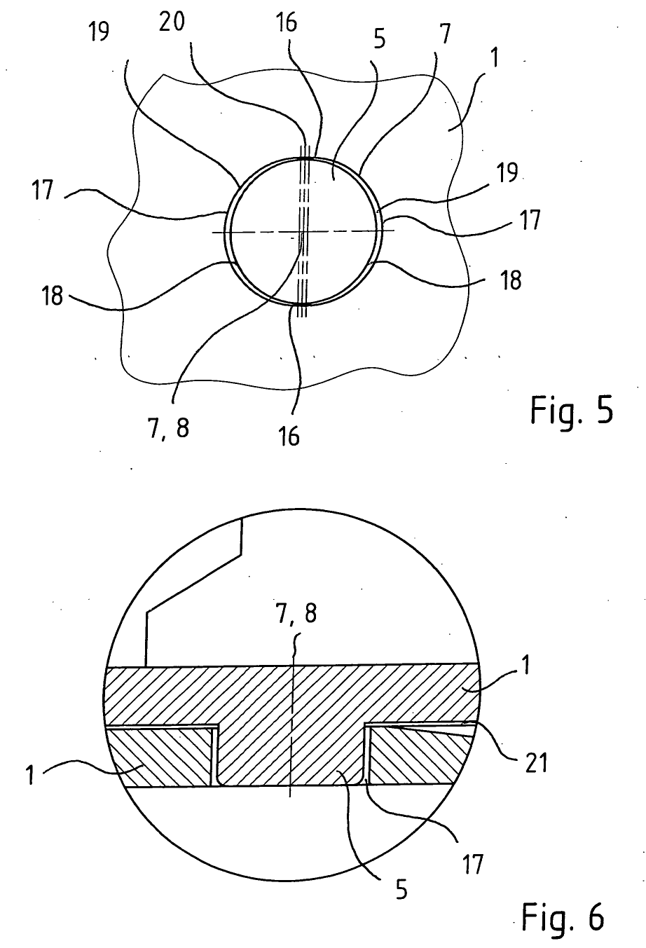

The articulated body may also be designed as a solid body. Such a one is illustrated in FIG. 6. FIGS. 5, 6 show the articulated connection between two adjacent chain links.

Each articulated body 5 is of essentially cylindrical design. The articulated mount 6 has an essentially oval cross section. The articulated body 5 and the articulated mount 7 each have a casing section forming a common connecting region 16. The connecting region 16 extends essentially in the longitudinal direction of the chain side plate 1. By between the diametrically opposite connecting regions 16, a gap 19 is formed between an outer casing region 17 of the articulated mount 5 and an inner casing region 18. The articulated connection has two essentially diametrically opposite gaps 19 which, in the exemplary embodiment illustrated, are of sickle-shaped design. They extend, as viewed in the circumferential direction of the articulated body 5, from the connecting region 16 as far as the opposite connecting region 16. The gap 19 between the articulated body 5 and the articulated mount 6 makes it possible for adjacent chain links to be able to pivot. The chain links can be pivoted about a pivot axis 20 which lies essentially perpendicularly to the axis of articulation 7 or 8.

The respective clearance 21 is formed between the overlapping end regions of the chain side plates of an adjacent chain links, said clearance making it possible for adjacent chain links to be able to pivot about the pivot axis 20.

Each chain link of a power transmission chain can be deflected about an axis of articulation 7 or 8 and about a pivot axis 20, with the result that adjacent chain links of a power transmission chain can be deflected in a spatially limited manner, i.e. in a three-dimensional space. A power transmission chain can be formed entirely or in some sections by chain links designed in such a manner.

To limit the ability of adjacent chain links to pivot about an axis of articulation 7 or 8, a stop 22 is provided. The opposite end region of the side plate of the chain link has a stop surface corresponding to the stop 22. Depending on the configuration of the stop/stop surface, a prestress can also be introduced into the power transmission chain.

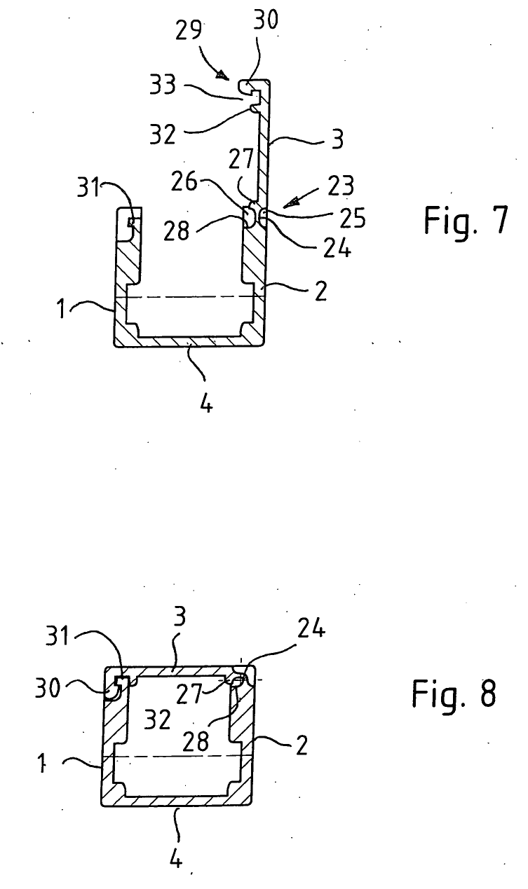

It is apparent from FIGS. 1 and 2 that the transverse web 3 is connected to the side plate 2. The connection is of articulated design. The transverse web 3 can be connected releasably at its opposite end to the side plate 1. The connection of the transverse web 3 to the side plate 2 is formed by a film hinge 23. The film hinge 23 is formed as a single piece with the side plate 2. Gaps are provided on both sides of the film hinge 23. The film hinge is formed by a film web 24 which is connected to the side plate 2 at one end and to the transverse web 3 at the other end. The thickness of the film web 24 is essentially smaller than the thickness of the side plate 2. To form the film web 24, recesses 25, 26 are provided transversely and in the longitudinal direction in the edge region of the side plate 2, as illustrated in FIG. 7.

In the region of the film hinge 23, the transverse web 3 has a projection 27 extending transversely with respect to the longitudinal direction of the transverse web. In the closed state of the chain link, the projection 27 rests on an edge 28 of the recess 26. This results in the film hinge 24 being relieved from load if a force is exerted on the transverse web 3 in the direction of the transverse web 4 on the transverse web 3.

The transverse web 3 has a blocking element 29 at its free end. The blocking element 29 is formed by a hook 30 which interacts with a mating hook 31 which is formed in a relief in an edge region of the side plate 1. A projection 32 is provided at a distance from the hook 30 and, together with the hook 30, limits a space 33 in which the mating hook 31 engages. The projection 32 bears with its one end surface against the inner surface of the side plate 1, as is apparent from FIG. 8. The projection 32 at least reduces, if not entirely avoids, movability and therefore stressing of the film hinge, since a movement of the transverse web 3 in the longitudinal direction of the transverse web is prevented.

A power transmission chain according to the invention for guiding lines, tubes or the like between a positionally fixed and a movable connection has a plurality of chain links connected to one another in an articulated manner. The chain links can be designed, for example, in accordance with the chain link illustrated in FIGS. 1 to 8. It is not absolutely necessary for the power transmission chain to be composed exclusively of chain links of this type. There is the possibility of, for example, some of the chain links being designed in accordance with the invention. Thus, depending on the intended use, a power transmission chain can be formed, for example, by means of chain links as illustrated in FIGS. 1 to 8, with every second chain link being a standard chain link. A power transmission chain according to the invention is suitable in particular for use in a sliding door system for, preferably, a vehicle, since, with the high stability of the power transmission chain, a multiplicity of lines can be guided therein.

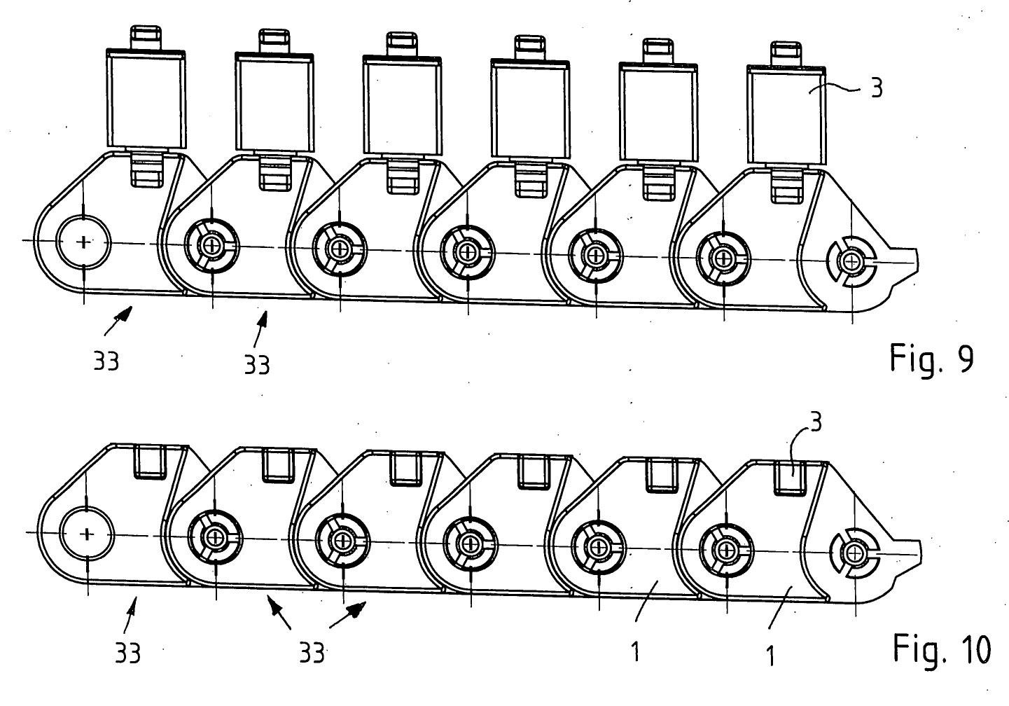

FIG. 9 illustrates a section of a power transmission chain for guiding lines, tubes or the like between a positionally fixed and a movable connection. The power transmission chain is formed by chain links 33 connected to one another in an articulated manner. The chain links 33 correspond essentially to the configuration of the chain link as illustrated in FIGS. 1 to 8. In the open state of the power transmission chain, lines, tubes or the like can be placed into or removed from the power transmission chain. In the closed state of the chain links, the transverse webs 3 are connected to the respective side plates 1.

FIGS. 9 and 10 show a section of the power transmission chain in a stretched state. During the use of a power transmission chain, the latter has an upper strand and a lower strand which are connected to each other by a region of curvature. In the power transmission chain, it is proposed that the transverse webs 3 are situated on the inside while the transverse webs 4 are situated on the outside. With regard to the fact that the transverse webs 4 are of essentially plate-like design, the power transmission chain can be essentially closed from the outside during operation, with the result that no objects could pass, for example, into the interior of the chain.

### LIST OF DESIGNATIONS

1 Side plate
2 Side plate
3 Transverse web
4 Transverse web
5 Articulated body
6 Articulated mount
7, 8 Axis of articulation
9 Line
10 Side edge
11 Side edge
12 Slot
13 Articulated body segment
14 Collar
15 Depression
16 Connecting region
17 Inner casing region
18 Outer casing region
19 Gap
20 Pivot axis
21 Clearance
22 Stop
23 Film hinge
24 Film web
25 Recess
26 Recess
27 Projection
28 Edge
29 Blocking element
30 Hook
31 Mating hook
32 Projection
33 Chain link

1. A chain link for a power transmission unit for guiding lines, tubes or the like, with two side plates which are connected to each other by at least one transverse web, each side plate having an end region which is intended for the articulated connection to another side plate, characterized in that the distances of the axes of articulation from the longitudinal edges of the side plates differ.

2. The chain link as claimed in claim 1, characterized in that the ratio of the smaller distance to the larger distance is smaller than 0.9, preferably smaller than 0.7.

3. The chain link as claimed in claim 1, characterized in that the side plates are of essentially trapezoidal design.

4. The chain link as claimed in claim 1, characterized in that at least one stop is provided to limit a deflection.

5. The chain link as claimed in claim 1, characterized in that the one end region has an articulated body and the other end region has an articulated mount.

6. The chain link as claimed in claim 5, characterized in that the articulated body is of essentially cylindrical design and the articulated mount has an essentially oval cross section.

7. The chain link as claimed in claim 5, characterized in that the articulated body has an essentially oval cross section and the articulated mount has a circular cross section.

8. The chain link as claimed in claim 1, characterized in that it is at least partially formed from at least one plastic.

9. A power transmission chain for guiding lines, tubes or the like between a positionally fixed and a movable connection, with chain links which are connected to one another in an articulated manner and in each case limit a channel section extending in the direction of the power transmission chain, each chain link having two side plates which are connected to each other by at least one transverse web, each side plate in each case having an end region which is intended for the articulated connection to a side plate of another chain link, characterized by at least one chain link, the side plates of which are designed in such a manner that the distances of the axes of articulation from the longitudinal edges of the side plates differ.

10. The power transmission chain as claimed in claim 9, characterized in that the ratio of the smaller distance to the larger distance is smaller that 0.9, preferably smaller than0.7.

11. The power transmission chain as claimed in claim 9, characterized in that the side plates of at least one chain link are of essentially trapezoidal design.

12. The power transmission chain as claimed in claim 9, characterized in that at least one chain link is provided with at least one stop to limit a deflection.

13. The power transmission chain as claimed in claim 9, characterized in that at least two chain links are provided which are designed in such a manner that the one end region has an articulated body and the other end region has an articulated mount.

14. The power transmission chain as claimed in claim 9, characterized in that a respective clearance is provided between the partially overlapping side plates of two adjacent chain links, in that the articulated body has two diametrically opposite outer casing regions and the articulated mount has two diametrically opposite inner casing regions and only the outer casing regions and the inner casing regions bear against one another.

15. The power transmission chain as claimed in claim 14, characterized in that the normals of the outer casing regions and of the inner casing regions run essentially perpendicularly to the longitudinal direction of the power transmission chain.

16. The power transmission chain as claimed in claim 9, characterized in that the articulated body is of essentially cylindrical design and the articulated mount has an essentially oval cross section.

17. The power transmission chain as claimed in claim 9, characterized in that the articulated body has an essentially oval cross section and the articulated mount has a circular cross section.

18. The power transmission chain as claimed in claim 9, characterized in that two adjacent chain links can be pivoted relative to each other in an angular range of up to approx. 45°.

19. The power transmission chain as claimed in claim 9, characterized in that the articulated body is formed from articulated body segments separated from one another by slots.

20. The power transmission chain as claimed in claim 9, characterized in that the articulated body has a radially outwardly directed collar in the region of its free end section.

21. The power transmission chain as claimed in claim 20, characterized in that a depression in which the collar engages with play is provided concentrically with respect to an articulated mount.

22. The power transmission chain as claimed in claim 9, characterized in that at least one transverse web can be connected releasably at one end to a side plate and is connected to the other side plate by a film hinge

23. The power transmission chain as claimed in claim 22, characterized in that, in the region of the film hinge, the transverse web has at least one projection, so that, in a closed position, the projection is connected in a latching manner to an edge of the side plate.

24. The power transmission chain as claimed in claim 9, characterized in that the transverse web forms a cover.

25. The power transmission chain as claimed in claim 9, characterized in that at least one side plate has a stop element at one end and a stop surface at the other end, the stop surface being formed essentially parallel to a central plane of the side plate.
